(19) United States
(12) Patent Application Publication
(10) Pub. No.: US 2007/0144326 A1
(43) Pub. Date: Jun. 28, 2007

(54) Safety cutter for cutting vegetables into spirals

(75) Inventor: Julien de Buyer, Le Val d'Ajol (FR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: DE BUYER INDUSTRIES, Le Val d'Ajol (FR)

(21) Appl. No.: 11/360,183

(22) Filed: Feb. 23, 2006

(30) Foreign Application Priority Data
Dec. 28, 2005 (FR) 05 54 118
Jan. 20, 2006 (FR) 06 50 201

(51) Int. Cl. B26D 5/20; B26D 11/00

(52) U.S. Cl. 83/865; 83/274; 83/932

(57) ABSTRACT

Safety cutter for cutting vegetables into spirals comprising:
a frame (30) which is provided with a spiral-cutting knife (15) which is mounted transversely facing an aperture for the passage of the cut vegetables,
a casing (12) which defines a space (13) for receiving vegetables to be cut,
a spiral-cutting pushing member (1) comprising a crank (6), and means for locking the casing, characterised in that
   the spiral-cutting knife (15) is constituted by a removable knife body (16) which can be positioned and snapped onto the frame (30) and which is provided, at the central portion thereof, with a centering pin (18) which is intended to be embedded in the flesh of a vegetable to be cut and, over one half of the length thereof, with a recess, in the region of which a transverse half-blade (17) is fixed.

The present invention relates to a safety cutter for cutting vegetables into spirals.

According to the invention, the word “vegetables” should be understood in a very broad sense and the vegetables which are cut may be not only any type of vegetable in the strict sense (potatoes, cucumbers, courgettes, carrots, . . . ), but also fruit or other foods suitable for being cut into spirals.

There are currently on the market various types of manual vegetable cutter which have in common the fact that they are not very practical and expose their users to serious risks of cuts to the hands.

At the same time, there are also many vegetable cutters or electric food processors of a versatile nature intended for domestic use or for industries or collectives.

As a general rule, however, these are sophisticated appliances which, in addition to their high cost, often have the disadvantage of being inconvenient to use and also difficult to clean.

In order to overcome this disadvantage, in accordance with document FR 2 825 043, a simple, practical and inexpensive manual longitudinal vegetable cutter has been proposed which allows the cutting characteristics to be varied selectively and allows working as required with more or less product to be processed, and which further does not expose the user to serious risks of cuts.

This known device, which is referred to by specialists as a “slicer” comprises:
a frame which is provided with two parallel lateral uprights which define two lateral rails as well as at least one cutting blade which is mounted transversely facing an aperture for the passage of the cut vegetables,
a guide chamber which is guided back and forth in terms of translation along the guiding rails and which defines, at the inner portion thereof, a space for receiving vegetables to be cut, and
a pushing member which fits on the guide chamber.

This pushing member is intended to be gripped manually by the user in order to be moved back and forth along the guiding rails with the guide chamber, with a pressure being applied continuously to the vegetables which are contained in the receiving space in order to press them against the cutting blade(s) mounted on the frame and allow them to be cut by this/these blade(s).

This safety vegetable cutter has the advantage of enabling many different types of preparation to be readily performed (smooth or corrugated discs, crinkle-cutting, dicing, . . . ) and has therefore been very well received by users.

It also has many other advantages which are connected, in particular, to the simplicity of the system for adjusting the cutting blades which allows excellent cutting quality, its compactness for storage, and also its easy maintenance, particularly using a dishwasher.

However, this manual safety vegetable cutter does not enable vegetables to be cut into ribbons or strips of quite considerable length unless the guide chamber/pushing member assembly is not used.

Julienne vegetables similar in shape to lasagne or long tagliatelle pieces are currently greatly appreciated by consumers who have no other alternative but to produce them by hand.

In this context, and in order to obtain julienne vegetables of this type, it has been proposed, in accordance with document FR 2 861 629, to provide an accessory for cutting vegetables into spirals that is capable of being fitted on the frame of the longitudinal vegetable cutter described in document FR 2 825 043.

A device of this type comprises:
a casing which has a substantially circular cross-section and which is guided in terms of translation along the guiding rails and which defines, at the inner portion thereof, a space for receiving vegetables to be cut,
a hollow spiral-cutting pushing member in the form of a cap which fits on the casing and which comprises, at the inner portion thereof, a support plate forming a base which is, on the one hand, fixedly joined, at one of the faces or the first face thereof, to a central rotating shaft which is extended at the opposite end thereof by a crank which extends from the spiral-cutting pushing member through a guiding opening which is drilled therein and, on the other hand, is provided, at the other face or second face thereof, with a series of spikes which are intended to be embedded in the flesh of the vegetables to be cut in order to retain them as they are pressed against the spiral-cutting knife mounted on the frame in order to allow them to be cut into spirals when the user activates the crank, with a pressure being applied in the direction of the frame, and
means for locking the casing in a position such that the rotating shaft of the spiral-cutting pushing member is located facing the aperture for passage of the cut vegetables.

Such a spiral-cutting device in which the spiral-cutting blades were the same as those used to carry out the longitudinal cutting in accordance with document FR 2 825 043 has not been found to be entirely satisfactory.

The object of the present invention is to overcome these disadvantages by providing a safety spiral vegetable cutter which is especially suitable for cutting into spirals.

A vegetable cutter of this type may advantageously correspond to an accessory which is suitable for a manual safety vegetable cutter as described in document FR 2 825 043, but can also be independent without thereby departing from the scope of the invention.

A safety spiral vegetable cutter of this type is characterised in that the spiral-cutting knife is constituted by a substantially planar removable knife body which is preferably of synthetic material and which can be positioned and snapped onto the frame and which is provided, on the one hand, at the central portion thereof, with a centering pin which is intended to be embedded in the flesh of a vegetable to be cut and, on the other hand, over one half of the length thereof, with a recess, in the region of which a transverse half-blade is fixed.

When the user activates the crank by applying a pressure in the direction of the frame, a vegetable which is introduced and centred in the receiving space rotates about itself and is cut into spirals.

A configuration of this type allows satisfactory cutting to be obtained in so far as the vegetable to be cut is centred and locked in the casing during the cutting operation, and, during each rotation, the vegetable to be cut passes below the half-blade which allows a regular and symmetrical spiral to be obtained.

The vegetable cutter according to the invention thus allows a wide range of cuts to be carried out: it allows in particular a vegetable to be cut in the form of a corolla which is retained at the centre thereof so that it may be reconstituted.

It is also thus possible to obtain “spiral lasagne pieces” by hollowing out the vegetable beforehand at the centre thereof, in particular using an apple-corer, or slices by scoring the vegetable from the central hole in accordance with a radius or diametrically.

According to another feature of the invention, the knife body is extended at each of the ends thereof by respective gripping end-pieces.

These end-pieces are intended to be gripped successively by a user and introduced from the inner portion of the frame into openings which are drilled for this purpose in the lateral uprights thereof, without any risk of injury following contact with the cutting half-blade.

One of the gripping end-pieces is preferably provided with a snap tongue which allows the spiral-cutting knife to be retained on the frame.

The knife body may further advantageously be provided with reference points which ensure that the half-blade is always inserted onto the frame in the correct direction.

It should be noted, according to the invention, that the presence of the centering pin prevents the spiral-cutting knife from being introduced in a sliding manner into the openings which have been drilled in the lateral uprights as in document FR 2 825 043.

According to another feature of the invention, the spiral vegetable cutter also comprises at least one removable longitudinal-cutting knife which is provided, over one half of the length thereof, with a group of equidistant blades which are directed substantially perpendicularly relative to the transverse half-blade so as to allow the vegetables to be cut into the shape of calibrated thin spiral strips in the form of tagliatelle pieces.

The frame may advantageously be provided with a series of cutting knives of this type whose blades have a larger or smaller spacing in order to obtain wider or narrower spiral-shaped tagliatelle pieces.

According to the invention, the rotating shaft and the crank are preferably constituted by two components which are screwed one onto the other, respectively, in order to allow the pushing member to be disassembled and therefore facilitate the cleaning thereof.

According to another preferred feature of the invention, the device comprises means for adjusting the cutting height in order to allow slices, lasagne-like pieces, or spiral-shaped tagliatelle pieces of different thicknesses to be obtained.

These means for adjusting the cutting height may in particular advantageously be constituted by a ramp which is movable in terms of translation parallel with the cutting plane as described in document FR 2 825 043.

It is thus possible to constantly maintain the ramp for adjusting the cutting height parallel with itself and consequently adjust the cutting height whilst ensuring that the first end of the ramp facing the spiral-cutting knife remains at a constant and very short distance from this knife.

A configuration of this type allows the cut to be optimised owing to the short ramp/knife passage distance which ensures optimum precision and regularity.

According to another particularly advantageous feature of the invention, the means for locking the casing are constituted by a collar which surrounds the casing at the periphery thereof and which is extended by two branches which are provided, respectively, at the free end thereof, with locking studs which are capable of snapping into notches which are provided for this purpose in the guiding rails of the frame.

This collar is preferably substantially rectangular and comprises opposing edges which are folded down, defining two sliding members which have a substantially U-shaped cross-section and which co-operate with the guiding rails of the frame.

When the vegetable cutter is assembled, the user can thus slide the collar and the casing along the guiding rails of the frame until the studs provided at the ends of the branches snap into the notches provided for this purpose.

The length of these branches is, of course, determined so that, in this locking position, the rotating shaft of the spiral-cutting pushing member is located facing the aperture for passage of the cut vegetables and the centering pin is located at the centre of the casing.

According to another advantageous feature, the face of the support plate forming a base which comprises a series of spikes comprises a blind hole in which the pin comes into abutment so that, once the pin is in abutment, the distance between the face of the plate carrying the spikes and the blade(s) is greater than the height of the spikes. A stop of this type prevents the spikes from coming into contact with the blade. This, on the one hand, prevents the spikes from being cut by the blade and, on the other hand, prevents them from damaging the blade.

In order to allow the vegetable cutter to be assembled, it is generally necessary to provide the casing with a central score which allows the passage of the pin of the spiral-cutting knife.

The features of the safety spiral vegetable cutter to which the invention relates will be described in greater detail with reference to the non-limiting appended drawings, in which:

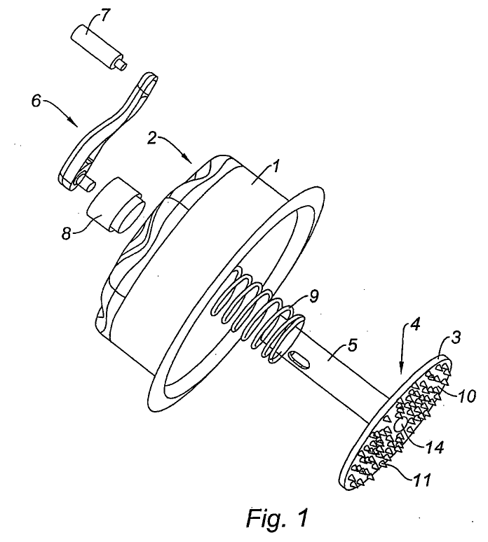

FIG. 1 is an “exploded” perspective view of the pushing member,

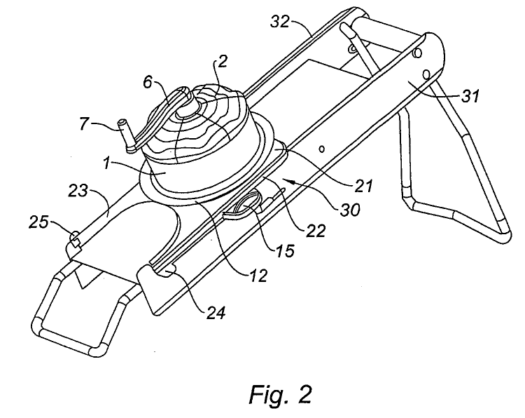

FIG. 2 is a perspective view illustrating the pushing member assembled on a manual safety vegetable cutter as described in document FR 2 825 043,

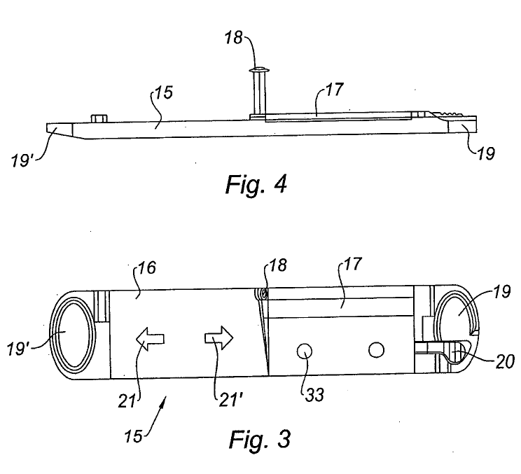

FIG. 3 is a plan view of the spiral-cutting knife,

FIG. 4 is a side view of this knife,

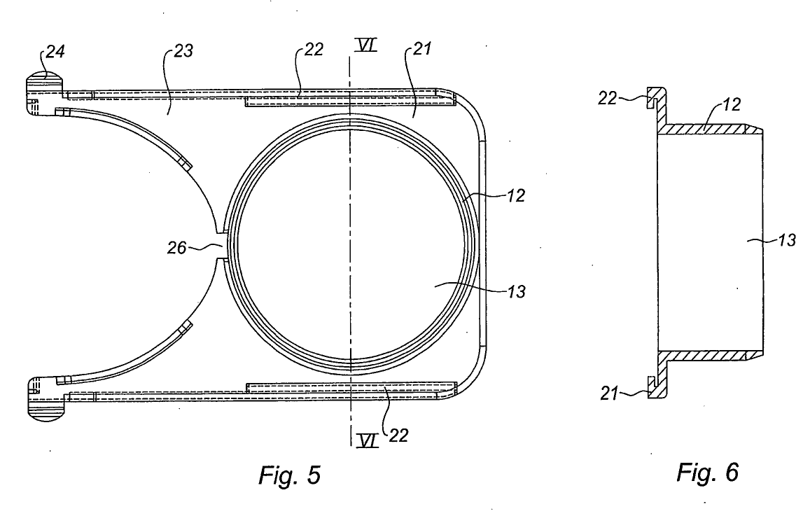

FIG. 5 is a plan view of the casing and the locking means thereof,

FIG. 6 is a section of FIG. 5 along axis VI-VI.

It should be noted that the pushing member advantageously corresponds to an accessory of the manual safety vegetable cutter described in document FR 2 825 043 but could also be mounted on another cutting device without departing from the scope of the invention.

According to FIG. 1, the spiral-cutting pushing member is substantially constituted by a cap-like hollow element 1 having a circular cross-section and having, at the upper portion 2 thereof, an ergonomic shape which facilitates the gripping thereof.

This element 1 is provided, at the inner portion thereof, with a circular support plate 3 which forms a base, a first face 4 of which is fixedly joined, in the region of the centre thereof, to a rotating shaft 5 which extends perpendicularly relative thereto and which is extended at the opposing end thereof by a crank 6 which comprises a rotating end-piece 7.

The rotating shaft 5 and the crank 6 are constituted by two independent components which are screwed one onto the other.

The free end of the rotating shaft 5 and the crank 6 extend beyond the upper face 2 of the cap-like element 1 via a guiding opening which is drilled in the centre of this face and in which a guiding sleeve 8 is further introduced.

A helical spring 9 is further mounted around the rotating shaft 5.

The ends of this spring 9 come into abutment against the first face 4 of the support plate 3 which forms a base and against the upper face 2 of the cap-like element 1 at the periphery of the guiding opening, on the inner face of this element, respectively.

According to FIG. 1, the second face 10 of the support plate 3 which forms a base is provided with a series of spikes 11 which are regularly distributed and a blind central hole 14 whose function will be described in greater detail in the remainder of this description.

According to FIG. 2, the pushing member 1 is fitted on a casing 12 which has a substantially circular cross-section and which defines, at the inner portion thereof, a space 13 for receiving the vegetables to be cut which is illustrated in greater detail in FIGS. 5 and 6.

This casing 12 is mounted on the guiding rails 32 of the frame 30 of a manual safety vegetable cutter as described in document FR 2 825 043 in place of the guide chamber with which this vegetable cutter is provided.

The features of this frame will not be described again in the context of this description for reasons of brevity.

According to FIG. 2, a removable spiral-cutting knife 15 is positioned transversely on the frame 30 facing an aperture for the passage of the cut vegetables and is snapped thereon.

According to FIGS. 3 and 4, the spiral-cutting knife 15 is constituted by a substantially planar knife body 16 of synthetic material provided, at the central portion thereof, with a recess in the region of which a transverse half-blade 17 is fixed by means of rivets 33.

The knife body 16 is further provided, at the central portion thereof, with a lateral centering pin 18 which is intended to be embedded in the flesh of a vegetable to be cut.

According to FIG. 3, the knife body 16 is extended at each of the ends thereof, by gripping end-pieces 19, 19′ which allow a user to position it on the frame 30 without any risk of injury following contact with the cutting half-blade 17.

During this operation, the user must successively introduce the gripping end-pieces 19, 19′ into openings which are drilled for this purpose in the lateral uprights 31 of the frame 30, from the inner portion of this frame.

One of the gripping end-pieces 19 is provided with a snap tongue 20 which allows the spiral-cutting knife 15 to be retained in the openings of the frame 30 after it has been positioned.

The knife body 16 is further provided with reference points 21, 21′ which serve to ensure that the half-blade 17 is always inserted in the correct direction.

It should be noted that the presence of the centering pin 18 prevents the spiral-cutting knife 15 from being introduced in a sliding manner into the openings which are drilled in the lateral uprights 32 from the outer portion of the frame 30.

According to FIGS. 2, 5 and 6, the casing 12 is surrounded by a substantially rectangular collar 21.

According to FIG. 6, two of the opposing edges 22 of this collar 21 are folded down so as to define U-shaped sliding members which are capable of co-operating with the guiding rails 32 of the frame 30.

According to FIGS. 2 and 5, the collar 21 is further extended by two branches 23 which are provided, respectively, at the free end thereof, with locking studs 24 which are capable of snapping into notches 25 provided for this purpose in the guiding rails 32 of the frame 30 in order to lock the casing 12 in terms of translation.

The length of the branches 23 is determined in such a manner that, in this locking position, the rotating shaft 5 of the spiral-cutting pushing member 1 is located facing the aperture for passage of the cut vegetables and the centering pin 18 is located at the centre of the casing 12.

According to FIG. 1, in this position, the centering pin 18 comes into abutment in the blind hole 14 of the second face 10 of the support plate 3 which forms a base.

In this abutment position, the distance between the second face 10 of the support plate 3 which forms a base and the spiral-cutting knife 15 is greater than the height of the spikes 11 which thus cannot come into contact with the half-blade 17.

According to FIG. 5, the casing 12 is further provided with a central score 26 which allows the passage of the centering pin 18 of the spiral-cutting knife 15.

1. Safety cutter for cutting vegetables into spirals comprising:
a frame provided with two parallel lateral uprights which define two lateral guiding rails and a spiral-cutting knife mounted transversely facing an aperture for the passage of the cut vegetables,
a casing which has a substantially circular cross-section and which is guided in translation along the guiding rails and which defines an inner space for receiving vegetables to be cut,
a hollow spiral-cutting pushing member in the form of a cap which fits on the casing and which comprises, at an inner portion thereof, a support plate having first and second faces and forming a base which is fixedly joined, at the first face thereof, to a central rotating shaft which is extended at the opposite end thereof by a crank which extends from the spiral-cutting pushing member through a guiding opening and is provided, at the second face thereof, with a series of spikes which are intended to be embedded in the flesh of the vegetables to be cut in order to retain them as they are pressed against the spiral-cutting knife mounted on the frame in order to allow them to be cut into spirals when the user activates the crank, with a pressure being applied in the direction of the frame, and
a lock for locking the casing in a position such that the rotating shaft of the spiral-cutting pushing member is located facing the aperture for passage of the cut vegetables,
wherein the spiral-cutting knife is constituted by a substantially planar removable knife body which can be positioned and snapped onto the frame and which is provided at the central portion thereof with a centering pin which is intended to be embedded in the flesh of a vegetable to be cut and over half of the length thereof with a recess, in the region of which a transverse half-blade is fixed.

2. Spiral vegetable cutter according to claim 1, wherein the knife body is extended at each of the ends thereof by respective gripping end-pieces which are intended to be gripped successively by a user and introduced from the inner portion of the frame into openings in the lateral uprights thereof.

3. Spiral vegetable cutter according to claim 2, wherein one of the gripping end-pieces is provided with a snap tongue which allows the spiral-cutting knife to be retained on the frame.

4. Spiral vegetable cutter according to claim 1, wherein the knife body is provided with reference points which ensure that the half-blade is always inserted onto the frame in the correct direction.

5. Spiral vegetable cutter according to claim 1, further comprising at least one removable longitudinal-cutting knife which is provided, over half of the length thereof, with a group of equidistant blades which are directed substantially perpendicularly relative to the transverse half-blade so as to allow the vegetables to be cut into the shape of spiral strips.

6. Spiral vegetable cutter according to claim 1, wherein the rotating shaft and the crank are constituted by two components which are screwed one onto the other.

7. Spiral vegetable cutter according to claim 1, further comprising an adjuster for the cutting height constituted by a ramp which is movable in terms of translation parallel with the cutting plane.

8. Spiral vegetable cutter according to claim 1, wherein the lock for the casing comprises a collar which surrounds the casing at the periphery thereof and which is extended by two branches which are provided at free ends thereof with locking studs capable of snapping into notches provided in the guiding rails of the frame.

9. Spiral vegetable cutter according to claim 8, wherein the casing is provided with a central score which allows the passage of the pin of the spiral-cutting knife.

10. Spiral vegetable cutter according to claim 1, wherein the second face of the support plate forming a base comprises a blind hole in which the pin comes into abutment so that, once the pin is in abutment, the distance between the second face of the support plate and the transverse half-blade is greater than the height of the spikes.

11. Spiral vegetable cutter according to claim 1, wherein the substantially planar removable knife body is of synthetic material.
